(19) United States
(12) Patent Application Publication
(10) Pub. No.: US 2007/0196804 A1
(43) Pub. Date: Aug. 23, 2007

(54) Question-answering system, question-answering method, and question-answering program

(75) Inventors: Hiroki Yoshimura, Kanagawa (JP); Hiroshi Masuichi, Kanagawa (JP); Takeshi Yoshioka, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/498,157

(22) Filed: Aug. 3, 2006

(30) Foreign Application Priority Data
Feb. 17, 2006 (JP) 2006-041631

(51) Int. Cl. G09B 7/00

(52) U.S. Cl. 434/323; 434/169

(57) ABSTRACT

A question-answering system that is formed with an information processing apparatus for processing information in accordance with a program, and obtains an answer to an input search question sentence by searching a knowledge source, includes: a background information set; a first answer candidate extracting unit; a first background information generating unit; an accuracy determining unit; and a first background information adding unit.

### BACKGROUND

1. Technical Field

The present invention generally relates to a question-answering system that obtains an answer to an input search question sentence by searching an information source, a method to be utilized in the question-answering system, and a program that can be executed in an information processing apparatus constituting the question-answering system.

2. Related Art

Conventional question-answering systems are roughly classified into two types. One is a so-called rule-based question-answering system. A rule-based question-answering system is formed with a typical question sentence pattern matching unit and an answer retrieving unit. The typical question sentence pattern matching unit searches a knowledge source to obtain the information (rule information) relative to the rules about extracting an answer candidate in response to a search question sentence. For example, to extract an answer candidate “A” in response to a search question sentence “What is X?”, sentence patterns such as “A is X.” and “X is A.” are obtained as the rule information. This rule information is manually set. The answer retrieving unit searches the knowledge source to extract an answer candidate (answer candidates) from a sentence (sentences) in compliance with the sentence patterns defined by the rule information.

The other type is a so-called statistics processing question-answering system. This statistics processing question-answering system includes a question analyzing unit, an information retrieving unit, an answer extracting unit, and a ground presenting unit. The question analyzing unit extracts keywords from a search question sentence, and determines the question type indicating the object questioned by the question sentence. The information retrieving unit searches a knowledge source to extract search results (passages), using the keywords as the search queries. The answer extracting unit extracts an answer candidate from the passage, and the ground presenting unit presents the grounds for which the answer candidate is extracted.

### SUMMARY

An aspect of the present invention provides a question-answering system that is formed with an information processing apparatus for processing information in accordance with a program, and obtains an answer to an input search question sentence by searching a knowledge source, the question-answering system including: a background information set storing unit that stores a set of background information indicating relationship among the question sentence, search results obtained through a search that is contained in the knowledge source and is related to the question sentence, and an answer candidate that is extracted from the search results and can be an answer to the question sentence; a first answer candidate extracting unit that obtains search results by searching contained in the knowledge source based on analysis information relative to the question sentence obtained by analyzing the question sentence, the first answer candidate extracting unit extracting an answer candidate that can be an answer to the question sentence from the search results based on the set of background information stored in the background information set storing unit; a first background information generating unit that generates background information indicating relationship among the question sentence, the search result sentence obtained by the first answer candidate extracting unit, and the answer candidate extracted by the first answer candidate extracting unit; an accuracy determining unit that determines whether answer candidate extraction accuracy with respect to the set of background information reaches a predetermined standard in a case where the background information generated by the first background information generating unit is added to the set of background information stored in the background information set storing unit; and a first background information adding unit that adds the background information generated by the first background information generating unit to the set of background information stored in the background information set storing unit, when the answer candidate extraction accuracy reaches the predetermined standard.

### BRIEF DESCRIPTION OF THE DRAWINGS

Embodiments of the present invention will be described in detail based on the following figures, wherein:

FIG. 1 illustrates the structure of a question-answering system;

FIG. 2 is a flowchart of the operation of the question-answering system;

FIG. 3 illustrates the structure of a question-answering system in accordance with a first exemplary embodiment of the present invention; and

FIG. 4 illustrates the structure of a question-answering system in accordance with a second exemplary embodiment of the present invention.

### DETAILED DESCRIPTION

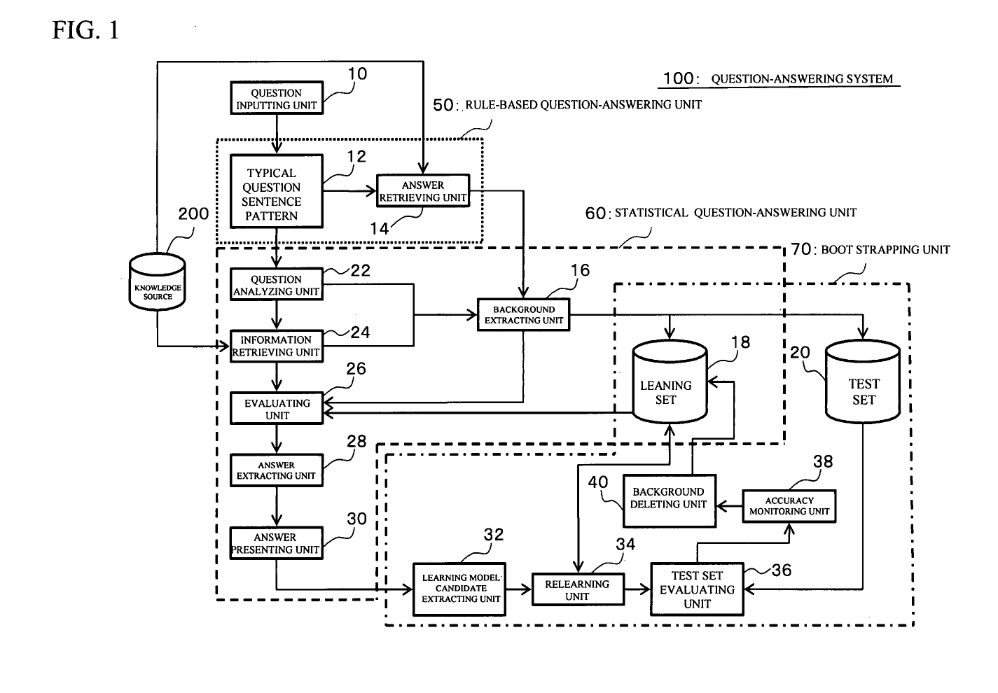

A description will now be given, with reference to the accompanying drawings, of exemplary embodiments of the present invention. FIG. 1 illustrates an example structure of a question-answering system. A question-answering system 100 shown in FIG. 1 is provided in an information processing device. In response to a digitized search question sentence, the question-answering system 100 searches a knowledge source 200 such as a search site on the Internet that includes a digitized search object sentence, so as to obtain an answer. This question-answering system 10 includes a question inputting unit 10, a typical question sentence pattern matching unit 12, an answer retrieving unit 14, a background extracting unit 16, learning set 18, test set 20, a question analyzing unit 22, an information retrieving unit 24, an evaluating unit 26, an answer extracting unit 28, an answer presenting unit 30, a learning model candidate extracting unit 32, a relearning unit 34, a test-set evaluating unit 36, an accuracy monitoring unit 38, and a background deleting unit 40.

The typical question sentence pattern matching unit 12 and the answer retrieving unit 14 constitute a rule-based question answering unit 50. The background extracting unit 16, the learning set 18, the question analyzing unit 22, the information retrieving unit 24, the evaluating unit 26, the answer extracting unit 28, and the answer presenting unit 30 constitute a statistical question answering unit 60. The learning set 18, the test set 20, the learning model candidate extracting unit 32, the relearning unit 34, the test set evaluating unit 36, the accuracy monitoring unit 38, and the identity deleting unit 40 constitute a boot strapping unit 70. The rule-based question answering unit 50, the statistical question answering unit 60, and the boot strapping unit 70 are formed with a CPU and memories, and are realized by the CPU executing a predetermined program.

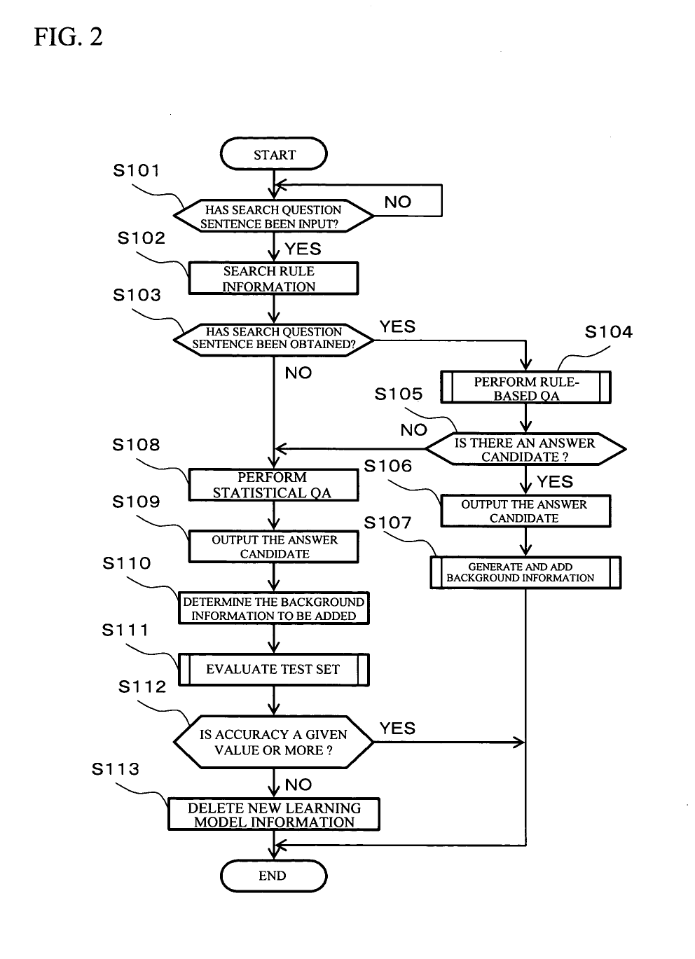

Referring now to a flowchart, the operation of the question-answering system 100 is described. FIG. 2 is the flowchart of the operation of the question-answering system 100. The question inputting unit 10 is a keyboard, for example. In accordance with an operation instruction from a user, the question inputting unit 10 outputs the character string of a search question sentence that is a sentence in a natural language to the typical question sentence pattern matching unit 12 in the rule-based question answering unit 50. The typical question sentence pattern matching unit 12 determines whether a search question sentence has been input thereto (S101). If a search question sentence has been input, the typical question sentence pattern matching unit 12 searches rule information for extracting answer candidates to the question sentences from the knowledge source 200 (S102).

More specifically, the typical question sentence pattern matching unit 12 stores rule information that is set manually in advance. In the rule information, the information as to sentence patterns and answer candidates including sentences “A is X” and “X is A” in response to a search question sentence “What/who/where/when is X?” is stored so that the answer candidate “A” can be extracted. The typical question sentence pattern matching unit 12 searches the stored rule information, and tries to obtain an answer to the input search question sentence.

The typical question sentence pattern matching unit 12 next determines whether the rule information in response to the input search question sentence has been obtained (S103). If the rule information has been obtained, the typical question sentence pattern matching unit 12 outputs the rule information together with the question sentence to the answer retrieving unit 14. The answer retrieving unit 14 then performs rule-based question answering (QA) (S104). More specifically, the answer retrieving unit 14 searches the knowledge source 200 to obtain passages of a search result corresponding to the sentence pattern represented by the rule information. Based on the information as to answer candidates contained in the rule information, the answer retrieving unit 14 tries to extract the answer candidates contained in the passage.

The answer retrieving unit 14 next determines whether the answer candidates have been extracted (S105). If the answer candidates have been extracted, the answer retrieving unit 14 outputs the answer candidates to a monitor or the like (not shown) to present the answer candidates to the user (S106).

The answer retrieving unit 14 also outputs the question sentence, the passages, and the answer candidates to the background extracting unit 16. The background extracting unit 16 generates the background information indicating the relationship among the question sentence, the passage, and the answer candidates supplied from the answer retrieving unit 14. The type of background information to be generated is manually set in advance, and the background extracting unit 16 generates background information of the preset type. The background extracting unit 16 also adds the generated background information to the learning set 18 and the test set 20 that store learning model information according to the machine learning method (S107). The learning model is a set of background information that is used in a statistical question answering operation (described later).

Meanwhile, in the case where the typical question pattern matching unit 12 determines in step S103 that rule information has not been obtained or the answer retrieving unit 14 determines in step S105 that answer candidates have not been extracted, answer candidates could not be obtained in the rule-based question answering operation. In such a case, the typical question pattern matching unit 12 outputs the question sentence to the question analyzing unit 22 to perform a statistical question answering operation.

When the question sentence is input to the question analyzing unit 22, the question analyzing unit 22, the information retrieving unit 24, the evaluating unit 26, and the answer extracting unit 28 perform a statistical question answering (QA) operation (S108). In the following, the statistical question answering operation is described in detail.

The question analyzing unit 22 carries out a known morphological analysis for the input question sentence so as to extract a keyword from the question sentence, and determines the question type representing the subject in question through the question sentence. The known morphological analysis is a Japanese morphological analysis employed in systems such as Chasen (see “Morphological Analysis System ChaSen 2.2.1 Users Manual” developed by Yuji Matsumoto, Akira Kitauchi, Tatsuo Yamashita, Yoshitaka Hirano, Hiroshi Matsuda, Kazuma Takaoka, and Masayuki Asahara of Nara Institute of Science and Technology, 2000, for example). Here, a keyword is a noun or an interrogative that can be a word to be used in information retrieving and determining the question type. Question types define question patterns that can be classified into names of persons, names of places, names of organizations, and the likes, based on the interrogative and the keyword in each question sentence. To determine question types, the question analyzing unit 22 includes a defining dictionary in which names of persons, names of organizations, and the likes are written in advance. Each question type is determined in accordance with a determining rule that is manually set (see “POSTECH Question-Answering Experiments at NTCIR-4 QAC”, by Seung-Hoon Na, In-Su Kang, and Jong-Hyeok Lee, Working Notes of NTCIR-4 Workshop, pp. 361-366, 2004, and the references cited therein). The question analyzing unit 22 outputs the keyword to the information retrieving unit 24, and outputs the question sentence and the question type to the background extracting unit 16.

The information retrieving unit 24 generates a search formula for the input keywords. The information retrieving unit 24 then searches the knowledge source 200 in accordance with the search formula to obtain the search results. The searching of the knowledge source 200 is based on AND searches with respect to the keywords. The searching is performed by a conventional search method such as Namazu or GETA (see http://www.namazu.org for Namazu, and http://www.getaex.nii.ac.jp for GETA). The information retrieving unit 24 outputs the obtained passages to the evaluating unit 26 and the background extracting unit 16.

The background extracting unit 16 receives the question sentence and the question type from the question analyzing unit 22, and the passage and the keyword(s) from the information retrieving unit 24. The background extracting unit 16 then extracts an answer candidate from the keyword(s) in the passage. Here, an answer candidate is a proper name that belongs to the same class as the question type. The background extracting unit 16 further generates background information representing the relationship among the question sentence, the passages, and the answer candidate, and outputs the background information and the answer candidate to the evaluating unit 26. For example, where the question sentence is represented by q, the feature word is Ti (i=1, . . . , x), the answer candidate is a, and the passage is pk (k=, . . . , z), the background information contains information such as the number of Ti in pk, the distance between a and Ti in pk, and the co-occurrence of a and Ti of Σpk.

The evaluating unit 26 evaluates the background information for each answer candidate supplied form the background extracting unit 16, by the machine learning method utilizing the learning model that is stored beforehand in the learning set 18. Here, the background information as to each answer candidate from the background extracting unit 16 has the same data structure as each set of background information forming the learning model stored in the learning set 18. The evaluating unit 26 outputs the value representing the evaluation (the evaluated value), the passages, and the answer candidates to the answer extracting unit 28.

The machine learning method involves a statistical method to input learning model and output the rules indicting the features of certain data. For example, by a machine learning method called “supervised learning”, evaluations are added to each set of the information forming the learning model information. By learning the relative rules between the features (the background) of each set of the information in the leaning model information and the evaluations of the background information, the evaluation of certain data can be predicted. There have been various kinds of supervised learning, such as ME (Maximum Entropy) (see “Machine Learning in Automated Text Categorization” by Fabrizio Sebaastiani, ACM Computing Surveys, Vol. 34, No. 1, pp. 1-47, 2002, and the references cited therein).

The answer extracting unit 28 extracts answer candidates corresponding to a predetermined number of upper values of the background information from the answer candidates contained in the input passage. More specifically, the answer extracting unit 28 carries out a known morphological analysis for the input passage, to extract the proper name contained in the passage. Based on the proper name, the answer extracting unit 28 extracts answer candidates corresponding to a predetermined number of upper values of evaluation of the background information. The proper name extraction is to automatically determine names of persons, names of organizations, names of places, and numbers contained in the passage, and to extract them as a proper name (see “Japanese Named Entity Extraction Using Support Vector Machine” by Hiroyasu Yamada, Taku Kudo, and Yuji Matsumoto, Information Processing, Vol. 43, No. 1, 2002, and the references cited therein). There established a matching relationship between the classes of proper names and question types.

The answer extracting unit 28 then outputs the extracted answer candidates, the background information corresponding to the answer candidates, and the values of evaluations of the background information, to the answer presenting unit 30 (S109). The answer presenting unit 30 is a monitor, for example, and presents answer candidates to the user. The user selects a correct one of the presented answer candidates.

In a conventional statistical question answering operation, a series of procedures comes to an end by presenting answer candidates. In this exemplary embodiment, however, the learning model information stored in the learning set 18 is updated so as to increase the accuracy in answer candidate extraction. In the following, the updating operation is described in detail.

The learning model candidate extracting unit 32 selects a predetermined set of background information among the sets of background information corresponding to the answer candidates, and determines the predetermined set of background information to be added to the learning model information stored in the learning set 18 (S110). More specifically, the learning model candidate extracting unit 32 obtains the answer candidate that is selected as a correct one by the user from the answer candidates presented by the answer presenting unit 30. The learning model candidate extracting unit 32 also obtains the answer candidates extracted by the answer extracting unit 28, the background information as to the answer candidates, and the values of evaluations of the background information, via the answer presenting unit 30. The learning model candidate extracting unit 32 further selects either the combination of the background information as to the answer candidate selected as a correct answer by the user and the background information with the highest evaluated value or the combination of the background information with the highest evaluated value and the background information with the lowest evaluated value, as the background information to be added to the learning set 18 (the additional background information candidate). The additional background information candidate thus determined is sent to the relearning unit 34.

The relearning unit 34 and the test set evaluating unit 36 evaluates the new learning model information having the additional background information candidate added thereto (a test set evaluating operation) (S111). More specifically, the relearning unit 34 reads the learning model information from the learning set 18, and adds the additional background information candidate to the learning model to generate new learning mode information. The relearning unit 34 further outputs the new learning model information to the test set evaluating unit 36 and stores the new learning model information under a different file name from the original learning model information in the learning set 18.

The test set evaluating unit 36 calculates the answer candidate extraction accuracy in a case where the new learning model information is used, and the answer candidate extraction accuracy in a case where the original learning model information (the learning model information for evaluation) stored in the test set 20 is used. Answer candidate extraction accuracies are defined by MMR (Mean Reciprocal Rank), which is widely used for indicating evaluations of natural-language question-answering systems. MMR is calculated in the following manner. Among the answer candidates extracted in response to the input question sentence, the inverse number of the appearing order of the correct answer is determined, and the average value of such inverse numbers of all question sentences is determined. As the obtained value is larger, the answer candidate extraction accuracy is higher. For example, where n represents the number of question sentences and Rank represents the appearing order of the correct answer among the answer candidates appearing in response to the subject question sentence, MMR is calculated by:

$$MMR = \frac{{\sum }_{i = 1}^{u} 1 / Rank}{n}$$

The calculated answer candidate extraction accuracy is sent to the accuracy monitoring unit 38.

The accuracy monitoring unit 38 compares the answer candidate extraction accuracy of the new learning model with the answer candidate extraction accuracy of the original learning model stored in the test set 20, and determines whether the answer candidate extraction accuracy of the new learning model information is higher than the answer candidate extraction accuracy of the original learning model stored in the test set 20 by a predetermined amount or more (for example, MMR is 0.01 or higher) (S112).

If the answer candidate extraction accuracy of the new learning model is not higher than the answer candidate extraction accuracy of the original learning model stored in the test set 20 by the predetermined amount or more, the accuracy monitoring unit 38 instructs the background deleting unit 40 to delete the new learning model. In accordance with this instruction, the background deleting unit 40 deletes the new learning model stored in the learning set 18 (S113). By doing so, the original learning model, which does not have the additional background information candidate added thereto, is used in a later statistical question answering operation.

If the answer candidate extraction accuracy of the new learning model is higher than the answer candidate extraction accuracy of the original learning model stored in the test set 20 by the predetermined amount or more, the new learning model stored in the learning set 18 is not deleted. Accordingly, the new learning model, which has the additional background information candidate added thereto, is used in a later statistical question answering operation.

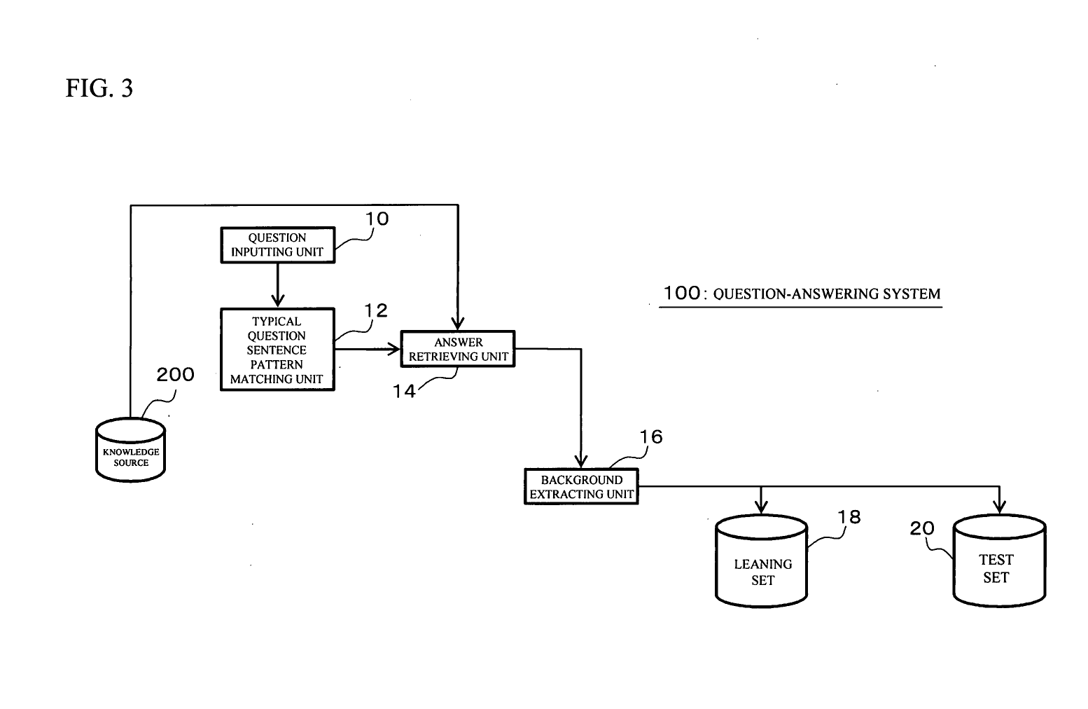

In the following, the operation of the question-answering system 100 is described by way of specific examples of search question sentences. First, a first exemplary embodiment for obtaining an answer candidate through a rule-based question answering operation is described. As shown in FIG. 3, only the question inputting unit 10, the typical question sentence pattern matching unit 12, the answer retrieving unit 14, the background extracting unit 16, the learning set database (DB) 18, and the test set 20 of the question-answering system 100 are used in the first exemplary embodiment.

When a question sentence “Where are the headquarters of the ISO (International Organization for Standardization) located?” is input from the question inputting unit 10, the typical question sentence pattern matching unit 12 tries to obtain the rule information relative to the question sentence. Here, information indicating that sentence pattern of the passage in accordance with the sentence pattern “Where is (are) X located?” of the question sentence is “X is (are) located in (at) A” and that each answer candidate is a proper name is obtained as the rule information. Also, information indicating each answer candidate in response to the interrogative “where” is a place name or an organization name is obtained as the rule information. Each of “X” and “A” in the question sentence and the passage sentence pattern is a character string consisting of N or less words. Here, N is an integer that can be arbitrarily set.

The answer retrieving unit 14 searches the knowledge source 200 to obtain the passages corresponding to the passage sentence pattern indicated by the rule information. Here, the obtained passages are: passage 1 “The headquarters of the ISO (International Organization for Standardization) are located in Geneva, Switzerland, and the representatives of the participant nations . . . ”: and passage 2 “The headquarters of the ISO (International Organization for Standardization) are located in Geneva, Switzerland, and the ISO is an organization for promoting standardization in science, technology, and trading, so as to achieve active international trade of products and services.”

The answer retrieving unit 14 further tries to extract answer candidates from the obtained passages. In accordance with the rule information, each of the answer candidates should be a proper name, and the proper name should be a place name or an organization name in response to the interrogative “where” in the question sentence. Accordingly, the answer retrieving unit 14 extracts “Geneva, Switzerland”, which is a proper name and a place name, as the answer candidate from both of the passages 1 and 2. The background extracting unit 16 generates the background information corresponding to the extracted answer candidate “Geneva, Switzerland”, the passages 1and 2, and the question sentence “Where are the headquarters of the ISO (International Organization for Standardization) located?”. The background extracting unit 16 then stores the background information in the learning set 18 and the test set 20.

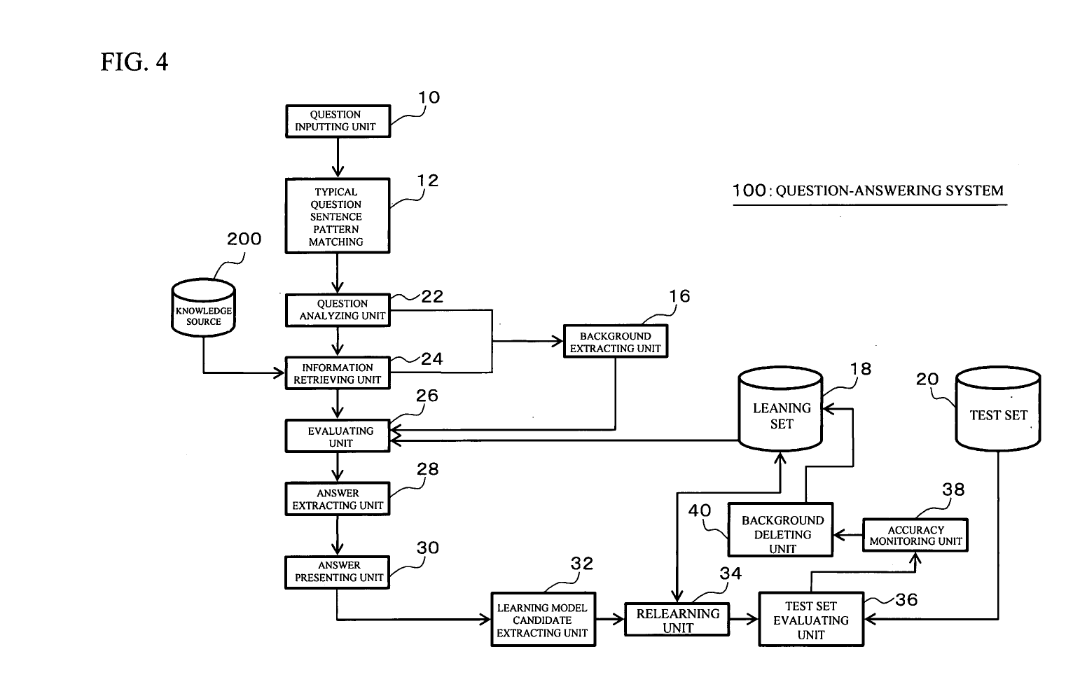

Next, a second exemplary embodiment for obtaining answer candidates through a statistical question answering operation is described. As shown in FIG. 4, the components of the question-answering system 100 other than the answer retrieving unit 14 are used in the second exemplary embodiment.

When a question sentence “Which high school won the second national championship in a row at Koshien Stadium in summer 2005?” is input from the question inputting unit 10, the typical question pattern matching unit 12 tries to obtain the rule information relative to the question sentence.

If the typical question sentence pattern matching unit 12 fails to obtain the rule information, the question analyzing unit 22 extracts the keywords “2005”, “summer”, “baseball tournament”, “consecutive championships”, and “high school”. The question analyzing unit 22 then determines the question type to be an organization name, based on the feature word “high school” that is most closely related to the interrogative “which”. The information retrieving unit 24 generates the search formula, based on the keywords extracted by the question analyzing unit 22. In accordance with the search formula, the question analyzing unit 22 searches the knowledge source 200, so as to obtain passages. The obtained passages are: passage 1 “The final of the 87th National High School Baseball Championship Tournament was held Koshien Stadium on Aug. 20, 2005, and Komadai-Tomakomai High School (representing South Hokkaido) won two consecutive championships”; and passage 2 “Two consecutive championships were won 57 years after Kokura High School (representing Fukuoka) made it”.

The background extracting unit 16 extracts answer candidates from the passages sent from the information retrieving unit 24. The answer candidates should be proper names belonging to the same class as the question type. The answer candidate extracted from the passage 1 is “Komadai-Tomakomai High School”, while the answer candidate extracted from the passage 2 is “Kokura High School”. The background extracting unit 16 further generates background information, based on the keywords and the passages obtained by the question analyzing unit 22 and the information retrieving unit 24.

Based on the background information generated for each answer candidate by the background extracting unit 16, the evaluating unit 26 carries out an evaluation by the machine learning method, using the learning model information stored in the learning set 18. Here, the evaluated value of the background information relative to the answer candidate “Komadai-Tomakomai High School” is higher than the evaluated value of the background information relative to the answer candidate “Kokura High School”.

Based on the evaluated values calculated by the evaluating unit 26, the answer extracting unit 28 extracts the answer candidate “Komadai-Tomakomai High School” contained in the passage 1 as the most probable answer candidate. The answer presenting unit 30 presents the most probable answer candidate “Komadai-Tomakomai High School” to the user. The answer presenting unit 30 may present two or more answer candidates in order of probabilities of the answer candidates.

The learning model candidate extracting unit 32 determines the background information relative to the most probable answer candidate “Komadai-Tomakomai High School” to be the additional background information candidate to be added to the learning model information stored in the learning set 18. The relearning unit 34 reads the learning model from the learning set 18, and generates new learning model information having the additional background information candidate added thereto. The test set evaluating unit 36 calculates the answer candidate extraction accuracy MMR of the new learning model information, and the answer candidate extraction accuracy MMR of the original learning model stored in the test set 20.

The accuracy monitoring unit 38 compares the answer candidate extraction accuracy of the new learning model with the answer candidate extraction accuracy of the original learning model stored in the test set 20. If the answer candidate extraction accuracy of the new learning model is higher than the answer candidate extraction accuracy of the original learning model stored in the test set 20 by a predetermined amount or more (for example, MMR is 0.01 or higher), the new learning model, which has the additional background information candidate added thereto, is used in a later statistical question answering operation.

As described above, in the question-answering system 100 of the present invention, the answer candidate obtained through the rule-based question answering operation is used as it is in a later statistical question answering operation, since the answer candidate is suitable as an answer. The background information indicating the relationship among the question sentence and the passage and the answer candidate in the rule-based question answering operation is added to the learning model information according to the machine learning method, and is used in a later statistical question answering operation. As for the background information indicating the relationship between the question sentence, and the passage and the answer candidate in statistics processing question answering, if the evaluated value is high, or if the answer candidate is suitable as an answer, the background information is added to the learning model and is used in a later statistical question answering operation. By reconstructing the optimum learning model, the answer candidate extraction accuracy in the statistical question answering operation can be increased.

In the rule-based question answering operation, answer candidates are suitable as answers, but the number of search question sentences corresponding to the rule information is not necessarily large. Therefore, there is a possibility that the background information is not updated since an answer candidate is not extracted. In such a case, an answer candidate is extracted through a statistical question answering operation. If the answer candidate extraction accuracy is high, the corresponding background information is added to the learning model. Since the learning model is often reconstructed, the optimum learning model can be generated as quickly as possible.

The learning set 18 of the above-described exemplary embodiments is equivalent to the background information set storing unit of the claims. The background extracting unit 16, the question analyzing unit 22, the information retrieving unit 24, the evaluating unit 26, and the answer extracting unit 28 are equivalent to the first answer candidate extracting unit. The background extracting unit 16 is equivalent to the first background information generating unit. The learning model candidate extracting unit 32, the relearning unit 34, the test set evaluating unit 36, the accuracy monitoring unit 38, and the background deleting unit 40 are equivalent to the accuracy determining unit and the first background information adding unit. The typical question sentence pattern matching unit 12 and the answer retrieving unit 14 are equivalent to the second answer candidate extracting unit. The background extracting unit 16 is equivalent to the second background information generating unit and the second background information adding unit. The test set 20 is equivalent to the evaluated background information set storing unit.

In the above-described exemplary embodiments, when an answer candidate is extracted in a rule-based question answering operation, the background information indicating the relationship between the question sentence, and the passage and the answer candidate obtained in the rule-based question answering operation, is added to the learning model. When an answer candidate is extracted in a statistical question answering operation and the evaluation of the background information indicating the relationship between the question sentence, and the passage and the answer candidate obtained in the statistical question answering operation, is high, the background information is added to the learning model. However, only the background information indicating the relationship between the question sentence, and the passage and the answer candidate obtained in the rule-based question answering operation, may be added to the learning model. In such a case, only the procedures of steps S101 through S109 of the flowchart shown in FIG. 2 are carried out.

More specifically, the typical question sentence pattern matching unit 12 determines whether a search question sentence has been input (S101). In the case where a question sentence has been input, the typical question sentence pattern matching unit 12 retrieves the rule information for extracting answer candidates relative to the question sentence from the knowledge source 200 (S102). The typical question sentence pattern matching unit 12 further determines whether the rule information relative to the input search question sentence has been obtained (S103). In the case where the rule information has been obtained, the typical question sentence pattern matching unit 12 outputs the rule information together with the question sentence to the answer retrieving unit 14. The answer retrieving unit 14 performs a rule-based question answering operation (S104).

The answer retrieving unit 14 then determines whether an answer candidate has been extracted through the rule-based question answering operation (S105). In the case where an answer candidate has been extracted, the answer retrieving unit 14 outputs the answer candidate to a monitor or the like, so as to present the answer candidate to the user (S106). The background extracting unit 16 generates the background information indicating the relationship among the question sentence, the passage, and the answer candidate. The background extracting unit 16 then stores the background information in the learning set 18 and the test set 20 (S107) In the case where the rule information has not been obtained in step S103 or where an answer candidate has not been obtained in step S105, the question analyzing unit 22, the information retrieving unit 24, the evaluating unit 26, and the answer extracting unit 28 perform a statistical question answering operation (S108). The answer extracting unit 28 then outputs the answer candidate extracted through the statistical question answering operation, the background information relative to the answer candidate, and the evaluated value of the background information, to the answer presenting unit 30 (S109).

As described above, since the answer candidate obtained through the rule-based question answering operation is suitable as an answer, only the background information indicating the relationship between the question sentence, and the passage and the answer candidate obtained through in the rule-based question answering operation, may be added as it is to the learning model information according to the machine learning method, and may be used in a later statistical question answering operation. In this manner, the optimum learning model can be reconstructed, and the answer candidate extraction accuracy in the statistical question answering operation can be increased.

In a case where the knowledge source 200 is a so-called FAQ site, for example, question sentences and passages containing answer candidates exist in the FAQ site. In this case, the answer retrieving unit 14 obtains a search question sentence and passages through a so-called robot search. The answer retrieving unit 14 further determines whether the sentence pattern of the passage is in compliance with the rule information relative to the question sentence. In the case where the sentence pattern is in compliance with the rule information, an answer candidate that is highly likely to be an answer can be obtained.

In such a case, even if there is not a search question sentence input in accordance with an operation instruction from the user, the background extracting unit 16 automatically generates the background information, and the learning model stored in the learning set 18 and the evaluation learning model stored in the test set 20 are reconstructed. Thus, the optimum learning model can be generated as quickly as possible.

Based on a search question sentence and an answer candidate obtained in accordance with an operation instruction from the user, the answer retrieving unit 14 may also generate another search question sentence and passages. In accordance with the question sentence and the passages, the answer retrieving unit 14 searches the knowledge source 200, to verify the authenticity of the answer candidate.

For example, based on a search question sentence “When was the Horyu-ji temple, famous as the oldest known wooden architecture, built?” and an answer candidate “year 607”, the answer retrieving unit 14 generates passages such as: “The Horyu-ji temple, famous as the oldest known wooden architecture, was built in year 607”, “The Horyu-ji temple, famous as the oldest wooden architecture built in year 607, was renovated in year 1980”, and “The famous Horyu-ji temple was built in year 607”. Based on these passages, the answer retrieving unit 14 searches the knowledge source 200. If there is a search result, the answer candidate “year 607” can be determined to be highly likely a correct answer. The background extracting unit 16 then generates background information, to reconstruct the learning model information stored in the learning set 18 and the evaluation learning model stored in the test set 20. The same operation as above can be performed in a case where another question sentence is generated and is used in searching the knowledge source 200.

The answer retrieving unit 14 may further generate rule information relative to another generated search question sentence and the passages, so that the rule information can be used in a later rule-based question answering operation.

In the background information evaluation, the evaluating unit 26 may utilize the SVM (Support Vector Machine), which is one of machine learning methods. In such a case, the evaluating unit 26 classifies the background information generated by the background extracting unit 16 into the background information relative to correct answers (positive examples) and the background information relative to incorrect answers (negative examples). The evaluating unit 26 then determines whether each answer candidate is a positive example or a negative example. Accordingly, the background information relative to each negative example is taken into consideration in constructing the learning mode information. Thus, the answer candidate extraction accuracy achieved with such learning model can be made even higher than the answer candidate extraction accuracy achieved in the case where the learning model is constructed only with the background information relative to the positive examples.

Also, a means of evaluating the evaluation learning model stored in the test set 20 may be employed. In such a case, the quality of the evaluation learning model can be increased further.

As described so far, in accordance with the present invention, the answer candidate extraction accuracy in each statistical question answering operation can be increased. Thus, an excellent question-answering system, method, and program can be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A question-answering system that is formed with an information processing apparatus for processing information in accordance with a program, and obtains an answer to an input search question sentence by searching a knowledge source,
the question-answering system comprising:
a background information set storing unit that stores a set of background information indicating relationship among the question sentence, search results obtained through a search that is contained in the knowledge source and is related to the question sentence, and an answer candidate that is extracted from the search results and can be an answer to the question sentence;
a first answer candidate extracting unit that obtains search results by searching contained in the knowledge source based on analysis information relative to the question sentence obtained by analyzing the question sentence, the first answer candidate extracting unit extracting an answer candidate that can be an answer to the question sentence from the search results based on the set of background information stored in the background information set storing unit;
a first background information generating unit that generates background information indicating relationship among the question sentence, the search result sentence obtained by the first answer candidate extracting unit, and the answer candidate extracted by the first answer candidate extracting unit;
an accuracy determining unit that determines whether answer candidate extraction accuracy with respect to the set of background information reaches a predetermined standard in a case where the background information generated by the first background information generating unit is added to the set of background information stored in the background information set storing unit; and
a first background information adding unit that adds the background information generated by the first background information generating unit to the set of background information stored in the background information set storing unit, when the answer candidate extraction accuracy reaches the predetermined standard.

2. The question-answering system according to claim 1, further comprising:
a second answer candidate extracting unit that obtains search results by searching contained in the knowledge source based on a search rule relative to the question sentence that is set in advance, the second answer candidate extracting unit extracting an answer candidate that can be an answer to the question sentence from the search results;
a second background information generating unit that generates background information indicating relationship among the question sentence, the search result sentence obtained by the second answer candidate extracting unit, and the answer candidate extracted by the second answer candidate extracting unit, when the answer candidate is successfully extracted by the second answer candidate extracting unit; and
a second background information adding unit that adds the background information generated by the second background information generating unit to the set of background information stored in the background information set storing unit.

3. The question-answering system according to claim 2, further comprising
an evaluation background information set storing unit that stores a set of evaluation background information indicating relationship among the question sentence, search results obtained by searching that is relative to the question sentence and is contained in the knowledge source, and an answer candidate that is extracted from the search results and can be an answer to the question sentence,
wherein:
the accuracy determining unit compares a value that represents answer candidate extraction accuracy based on the set of evaluation background information stored in the evaluation background information set storing unit, with a value that represents answer candidate extraction accuracy based on the set of evaluation background information obtained in a case where the background information generated by the first background information generating unit is added to the set of evaluation background information stored in the evaluation background information set storing unit; and
the first background information adding unit adds the background information generated by the first background information generating unit to the set of background information stored in the background information set storing unit, when the value that represents the answer candidate extraction accuracy based on the set of evaluation background information obtained in the case where the background information generated by the first background information generating unit is added to the set of evaluation background information stored in the evaluation background information set storing unit is larger than the value that represents the answer candidate extraction accuracy based on the set of evaluation background information stored in the evaluation background information set storing unit.

4. The question-answering system according to claim 3, wherein the set of evaluation background information is a set of background information generated by the second background information generating unit.

5. A question-answering system that is formed with an information processing apparatus for processing information in accordance with a program, and obtains an answer to an input search question sentence by searching a knowledge source,
the question-answering system comprising:
a background information set storing unit that stores a set of background information indicating relationship among the question sentence, search results obtained through a search that is contained in the knowledge source and is related to the question sentence, and an answer candidate that is extracted from the search results and can be an answer to the question sentence;
a first answer candidate extracting unit that obtains search results by searching contained in the knowledge source based on analysis information relative to the question sentence obtained by analyzing the question sentence, the first answer candidate extracting unit extracting an answer candidate that can be an answer to the question sentence from the search results based on the set of background information stored in the background information set storing unit;
a second answer candidate extracting unit that obtains search results by searching contained in the knowledge source based on a search rule relative to the question sentence that is set in advance, the second answer candidate extracting unit extracting an answer candidate that can be an answer to the question sentence from the search results;
a second background information generating unit that generates background information indicating relationship among the question sentence, the search results obtained by the second answer candidate extracting unit, and the answer candidate extracted by the second answer candidate extracting unit, when the answer candidate is successfully extracted by the second answer candidate extracting unit; and
a second background information adding unit that adds the background information generated by the second background information generating unit to the set of background information stored in the background information set storing unit.

6. A question-answering method to be utilized in a question-answering system that is formed with an information processing apparatus for processing information in accordance with a program, and obtains an answer to an input search question sentence by searching a knowledge source,
the method comprising:
a first answer candidate extracting step of extracting an answer candidate that can be an answer to the question sentence from search results obtained by searching contained in the knowledge source based on analysis information relative to the question sentence obtained by analyzing the question sentence, the answer candidate being extracted based on a set of background information that is stored beforehand in a memory device and indicates relationship among the question sentence, the search result sentence obtained by searching for the search object sentence that is related to the question sentence and is contained in the knowledge source, and the answer candidate that is extracted from the search results and can be an answer to the question sentence;
a first background information generating step of generating background information that indicates relationship among the question sentence, the search result sentence obtained in the first answer candidate extracting step, and the answer candidate extracted in the first answer candidate extracting step;
an accuracy determining step of determining whether answer candidate extraction accuracy with respect to the set of background information reaches a predetermined standard in a case where the background information generated in the first background information generating step is added to the set of background information stored in the memory device; and
a first background information adding step of adding the background information generated in the first background information generating step to the set of background information stored in the memory device, when the answer candidate extraction accuracy reaches the predetermined standard.

7. The method according to claim 6, further comprising:
a second answer candidate extracting step of extracting an answer candidate that can be an answer to the question sentence from search results obtained by searching contained in the knowledge source based on a search rule relative to the question sentence that is set in advance;
a second background information generating step of generating background information that indicates relationship among the question sentence, the search result sentence obtained in the second answer candidate extracting step, and the answer candidate extracted in the second answer candidate extracting step, when the answer candidate is successfully extracted in the second answer candidate extracting step; and
a second background information adding step of adding the background information generated in the second background information generating step to the set of background information stored in the memory device.

8. The method according to claim 7, wherein:
the accuracy determining step includes comparing a value that represents answer candidate extraction accuracy based on a set of evaluation background information that is stored beforehand in a memory device and indicates relationship among the question sentence, search results obtained by searching relative to the question sentence and contained in the knowledge source, and an answer candidate that is extracted from the search results and can be an answer to the question sentence, with a value that represents answer candidate extraction accuracy based on the set of evaluation background information obtained in a case where the background information generated in the first background information generating step is added to the set of evaluation background information stored in the memory device; and
the first background information adding step includes adding the background information generated in the first background information generating step to the set of background information stored in the memory device, when the value that represents the answer candidate extraction accuracy based on the set of evaluation background information obtained in the case where the background information generated in the first background information generating step is added to the set of evaluation background information stored in the memory device is larger than the value that represents the answer candidate extraction accuracy based on the set of evaluation background information stored in the memory device.

9. The method according to claim 8, wherein the set of evaluation background information is a set of background information generated in the second background information generating step.

10. A question-answering method to be utilized in a question-answering system that is formed with an information processing apparatus for processing information in accordance with a program, and obtains a correct answer to an input question sentence by searching a knowledge source,
the method comprising:
a first answer candidate extracting step of extracting an answer candidate that can be an answer to the question sentence from search results obtained by searching contained in the knowledge source based on analysis information relative to the question sentence obtained by analyzing the question sentence, the answer candidate being extracted based on a set of background information that is stored beforehand in a memory device and indicates relationship among the question sentence, the search result obtained by searching that is related to the question sentence and is contained in the knowledge source, and the answer candidate that is extracted from the search results and can be an answer to the question sentence;
a second answer candidate extracting step of extracting an answer candidate that can be an answer to the question sentence from search results obtained by searching contained in the knowledge source based on a search rule relative to the question sentence that is set in advance;
a second background information generating step of generating background information that indicates relationship among the question sentence, the search result sentence obtained in the second answer candidate extracting step, and the answer candidate extracted in the second answer candidate extracting step, when the answer candidate is successfully extracted in the second answer candidate extracting step; and
a second background information adding step of adding the background information generated in the second background information generating step to the set of background information stored in the memory device.

11. A program that can be executed in an information processing apparatus constituting a question-answering system that obtains an answer to an input search question sentence by searching a knowledge source,
the program comprising:
a first answer candidate extracting step of extracting an answer candidate that can be an answer to the question sentence from search results obtained by searching contained in the knowledge source based on analysis information relative to the question sentence obtained by analyzing the question sentence, the answer candidate being extracted based on a set of background information that is stored beforehand in a memory device and indicates relationship among the question sentence, the result sentence obtained by searching that is related to the question sentence and is contained in the knowledge source, and the answer candidate that is extracted from the search results and can be an answer to the question sentence;
a first background information generating step of generating background information that indicates relationship among the question sentence, the result sentence obtained in the first answer candidate extracting step, and the answer candidate extracted in the first answer candidate extracting step;
an accuracy determining step of determining whether answer candidate extraction accuracy with respect to the set of background information reaches a predetermined standard in a case where the background information generated in the first background information generating step is added to the set of background information stored in the memory device; and
a first background information adding step of adding the background information generated in the first background information generating step to the set of background information stored in the memory device, when the answer candidate extraction accuracy reaches the predetermined standard.

12. The program according to claim 11, further comprising:
a second answer candidate extracting step of extracting an answer candidate that can be an answer to the question sentence from search results obtained by searching contained in the knowledge source based on a search rule relative to the question sentence that is set in advance;
a second background information generating step of generating background information that indicates relationship among the question sentence, the search result sentence obtained in the second answer candidate extracting step, and the answer candidate extracted in the second answer candidate extracting step, when the answer candidate is successfully extracted in the second answer candidate extracting step; and
a second background information adding step of adding the background information generated in the second background information generating step to the set of background information stored in the memory device.

13. The program according to claim 12, wherein:
the accuracy determining step includes comparing a value that represents answer candidate extraction accuracy based on a set of evaluation background information that is stored beforehand in a memory device and indicates relationship among the question sentence, search results obtained by searching relative to the question sentence and contained in the knowledge source, and an answer candidate that is extracted from the search results and can be an answer to the question sentence, with a value that represents answer candidate extraction accuracy based on the set of evaluation background information obtained in a case where the background information generated in the first background information generating step is added to the set of evaluation background information stored in the memory device; and
the first background information adding step includes adding the background information generated in the first background information generating step to the set of background information stored in the memory device, when the value that represents the answer candidate extraction accuracy based on the set of evaluation background information obtained in the case where the background information generated in the first background information generating step is added to the set of evaluation background information stored in the memory device is larger than the value that represents the answer candidate extraction accuracy based on the set of evaluation background information stored in the memory device.

14. The program according to claim 13, wherein the set of evaluation background information is a set of background information generated in the second background information generating step.

15. A program that can be executed in an information processing apparatus constituting a question-answering system that obtains an answer to an input search question sentence by searching a knowledge source,
the program comprising:
a first answer candidate extracting step of extracting an answer candidate that can be an answer to the question sentence from search results obtained by searching contained in the knowledge source based on analysis information relative to the question sentence obtained by analyzing the question sentence, the answer candidate being extracted based on a set of background information that is stored beforehand in a memory device and indicates relationship among the question sentence, the search result obtained by searching that is related to the question sentence and is contained in the knowledge source, and the answer candidate that is extracted from the search results and can be an answer to the question sentence;
a second answer candidate extracting step of extracting an answer candidate that can be an answer to the question sentence from search results obtained by searching contained in the knowledge source based on a search rule relative to the question sentence that is set in advance;
a second background information generating step of generating background information that indicates relationship among the question sentence, the search result obtained in the second answer candidate extracting step, and the answer candidate extracted in the second answer candidate extracting step, when the answer candidate is successfully extracted in the second answer candidate extracting step; and
a second background information adding step of adding the background information generated in the second background information generating step to the set of background information stored in the memory device.
